(19) United States
(12) Patent Application Publication
(10) Pub. No.: US 2005/0195552 A1
(43) Pub. Date: Sep. 8, 2005

(54) Method and apparatus for triggering of lightning discharge

(76) Inventor: Tatsuo Torii, Naka-gun (JP)

Correspondence Address: WENDEROTH, LIND & PONACK, L.L.P., 2033 K STREET N. W., SUITE 800, WASHINGTON, DC, 20006-1021, US

(21) Appl. No.: 11/001,068

(22) Filed: Dec. 2, 2004

(30) Foreign Application Priority Data
Mar. 4, 2004 (JP) 2004-060214

(51) Int. Cl. H02H 1/04

(52) U.S. Cl. 361/212

(57) ABSTRACT

A method for triggering of lightning discharge which is high in lightning triggering efficiency and capable of surely triggering lightning discharge is provided. The method comprises collimating muons emitted from a high energy proton or electron accelerator, and irradiating the collimated muon beam toward a thundercloud to thereby promote ionization of air in the thundercloud and trigger lightning discharge. An apparatus for implementing the method for triggering of lightning is also provided. The apparatus comprises a high energy proton or electron accelerator from which a proton beam or an electron beam is emitted, a target from which pions are emitted by irradiating the target with the proton or electron beam, a collimator for collimating muons generated by the decay of the pions, and an accelerating tube for accelerating the collimated muon beam and irradiating the muon beam toward a thundercloud.

### FIELD OF THE INVENTION

The present invention relates to a method for artificial triggering of lightning discharge in which lightning discharge is triggered within a thundercloud to dissipate energy through the discharge and alleviate the damage caused by lightning strikes to ground facilities and persons, and an apparatus for artificial triggering of lightning discharge for implementing the method.

### BACKGROUND OF THE INVENTION

As a method for triggering lightning discharge, there have hitherto been proposed a method for triggering of lightning discharge using a rocket in which a rocket having a stretching metal wire is launched toward a thundercloud (see, for example, M. M. Newman et al., J. Geophys. Res., 72, 4761-4764 (1967)) and a method for triggering of lightning discharge using a laser in which a laser beam is irradiated toward a thundercloud and plasma generated in air by the laser beam is utilized to trigger lightning (see, for example, L. M. Ball, Appl. Opt., 13, 2292-2296 (1974)).

However, the method for triggering of lightning discharge using a rocket requires that the rocket is launched toward the strong electric field region in a thundercloud where lightning discharge possibly occurs; if the rocket does not reach such a region, there is a possibility that lightning discharge is not triggered and hence the lightning triggering efficiency of this method cannot necessarily be high. Additionally, there is a possibility that the spent rocket and the spent metal wire might come down to the ground.

On the other hand, the method of artificial triggering of lightning discharge using a laser requires the generation of plasma in air located between a laser injection nozzle and the thundercloud, and accordingly there has been a problem such that, in the case of winter thunderstorms, the plasma can hardly be generated because of the absorption of the laser beam by the ice crystals/snow in and below the thundercloud, and the lightning triggering efficiency is thereby degraded.

### SUMMARY OF THE INVENTION

An object of the present invention is to overcome the above-described problems in the prior art method for triggering of lightning discharge using a rocket or a laser and to provide a novel method for triggering of lightning discharge in which lightning discharge can be triggered more surely and high lightning triggering efficiency can thereby be obtained.

Another object of the present invention is to provide an apparatus for triggering of lightning discharge to implement the above-described novel method.

The present inventor found that when a beam of muons is irradiated toward a thundercloud, the muons can easily reach the target thundercloud because the muons are high in penetration, and the muons directly promote the ionization of the air in the thundercloud and can thereby trigger lightning discharge efficiently. The present invention is accomplished based on the above-described finding.

According to the present invention, there is provided a method for triggering of lightning discharge comprising collimating muons produced by a high energy proton or electron accelerator, and irradiating the collimated muon beam toward a thundercloud to thereby promote ionization of air in the thundercloud and trigger lightning discharge.

According to the present invention, there is also provided an apparatus for triggering of lightning discharge for implementing the method of the present invention. The apparatus comprises a high energy proton or electron accelerator from which a proton beam or an electron beam is emitted, a target from which pions are emitted by irradiating the target with the proton beam or electron beam, a collimator for collimating muons generated by the decay of the pions, and an accelerating tube for accelerating the collimated muon beam and irradiating the muon beam toward a thundercloud.

In the present invention, the following effects can be achieved.

(1) In contrast to the conventional method for triggering of lightning using a laser, a muon beam can be made to be incident into a thundercloud without being affected by the absorption of the beam by the moist air and/or snowing in and below the thundercloud.

(2) A large amount of electrons can be generated in a thundercloud through the acceleration and the collision of electrons, which is produced by the interaction between muons and air molecules in the thundercloud. In contrast to the conventional method for triggering of lightning discharge using a laser in which plasma is generated in the air located in the beam path, it comes to be possible to directly promote the ionization of the air in the thundercloud to thereby trigger lightning discharge and attain a high lightning triggering efficiency.

(3) In contrast to the conventional triggered lightning discharge method using a rocket, the muon beam can be continuously irradiated toward a thundercloud, and the irradiation can be repeated as many times as desired in such a way that the irradiation is directed toward the strong electric field region in the thundercloud in which region lightning discharge is caused.

(4) In contrast to the conventional triggered lightning discharge method using a rocket, there is no danger such that the spent rocket and the spent metal wire come down to the ground, and accordingly the safety is high.

(5) The positive (negative) muons decay into positrons (electrons) and the electrons are short in flying range, so that energy is locally absorbed into the region of the thundercloud in which region the muon beam has arrived, and hence no adverse effect is exercised on the other regions.

### BRIEF DESCRIPTION OF THE DRAWINGS

FIG. 1 is a diagram conceptually illustrating the triggered lightning discharge method of the present invention.

FIG. 2 illustrates a computational model in the simulation of lightning strikes based on the Monte Carlo calculation.

FIG. 3 is a diagram showing the tracks of muons, electrons and photons for the case where positive muons have been made to be incident into a thundercloud on the basis of the computational model shown in FIG. 2.

FIG. 4 is a graph showing the relation between the absorbed energy in the air along the irradiation direction of the muon beam and the irradiation distance.

FIG. 5 is a schematic diagram illustrating an example of the apparatus for triggering of lightning discharge of the present invention.

### DETAILED DESCRIPTION OF THE PREFERRED EMBODIMENT

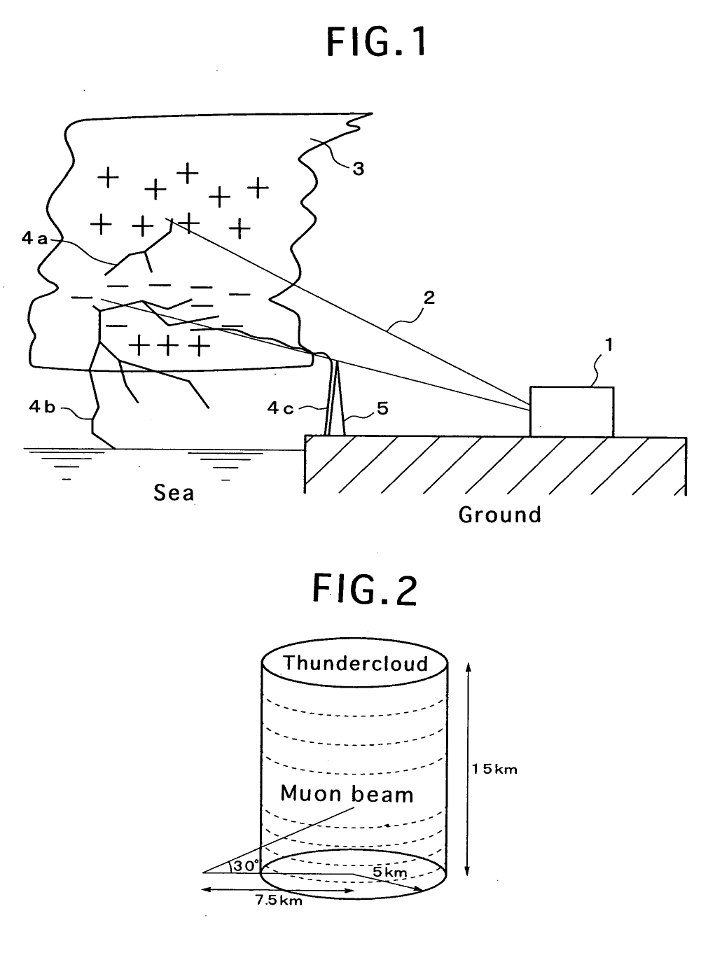

FIG. 1 is a diagram conceptually illustrating the triggered lightning discharge method of the present invention. The muons produced by a high energy proton or electron accelerator 1 are collimated, and irradiated as a muon beam 2 toward the strong electric field region of a thundercloud 3. When the energy of a muon is 2 GeV, the flying range of the muon is ten-odd kilometers, so that the muons can be irradiated toward a thundercloud at a distance of about ten kilometers. In an example shown in FIG. 1, the accelerator 1 is installed on the ground, and a muon beam 2 is irradiated toward a thundercloud above the sea.

A muon decays into either an electron, a neutrino and an antineutrino or a positron, a neutrino and an antineutrino, according to the following decay schemes.
μ⁺→e⁺νₑ\overline{ν}_{μ}
μ⁻→e⁻\overline{ν}ₑν_{μ}
μ⁺: Positive muon
μ⁻: Negative muon
e⁺: Positron
e⁻: Electron
νₑ: Electron neutrino
ν_{μ}: Muon neutrino

The upperlined ν represents antineutrino of the neutrino ν.

The charge distribution in a general thundercloud 3 is such that, as schematically shown in FIG. 1, the upper portion is positively charged, the lower portion is negatively charged, and a small positive charge layer (pocket positive charge) is present under the lower negative charge layer. A lightning discharge is generated when these charges become large and the positive and negative charges attract each other to cause discharge. The discharge generated within a thundercloud 3 is the in-cloud discharge 4a, and the discharge generated between the thundercloud 3 and the sea or the ground is the lightning strike 4b. By artificially triggering the in-cloud discharge while the charges accumulated within a thundercloud is still small, the associated energy can be dissipated and the effects of the lightning strike can be alleviated. By artificially triggering the lightning strike from a thundercloud in the sky above the sea or the area where ground facilities are scarce, the damages to the ground facilities and persons can be alleviated and thus the effects of lightning strikes can be made minimal.

In the present invention, the muons having positive or negative charge ionize the molecules of the air while the muons are flying through the air and generate a large amount of knock-on electrons. The knock-on electrons and the decay-electrons (positrons) produced by the negative (positive) muon decaying are accelerated in the strong electric field region in a thundercloud, collide with the molecules of the air, and thus secondary electrons and the bremsstrahlungs (photons) are emitted. These electrons and photons once again collide with the molecules of the air and further generate electrons and photons in large amounts in the state of avalanche, namely, the electromagnetic shower of electrons and photons. The electrons generated in this case are short in flying range and accordingly absorbed within the thundercloud, and in the meanwhile ionize the surrounding air to increase the electric conductivity of the air and thus facilitate the occurrence of the lightning discharge.

FIG. 1 shows, in addition to the lightning strike 4b caused by the lightning discharge occurring between a thundercloud 3 and the sea, the state in which discharge is developed along the path of the muon beam 2 and thus the lightning strike 4c to a steel tower 5 takes place. The phenomenon such that the lightning strike 4c to the steel tower 5 takes place may be ascribable to the possibility that a discharge path is formed along the path of the muon beam 2 in the following way: knock-on electrons are generated in the air along the path of the muon beam 2, a large amount of electrons are also generated in the thundercloud 3 along this path, and consequently electron-ion pairs are generated in the air to increase the electric conductivity along the path of the muon beam 2. In this way, by collecting and storing the electric energy from the lightning strike 4c occurring at the steel tower 5, the lightning strike can be positively utilized as an energy source.

Now, the results of the simulation, based on the Monte Carlo calculation, of the phenomenon of triggered lightning discharge according to the present invention will be described below. FIG. 2 illustrates the computational model; the height of a thundercloud is about 15 km in a summer thunderstorm and about 7 to 8 km in a winter thunderstorm, and accordingly, the height for computation is assumed to be 15 km. Additionally, the radius of the thundercloud for computation is assumed to be 5 km because the sizes of thunderclouds are all different from each other. The distance between the accelerator and the central part of the thundercloud is taken to be 7.5 km so that the decay of the muons may take place at the altitude where the electric field strength becomes highest in relation to an assumed value of 300 for the emission angle of the muon beam from the accelerator.

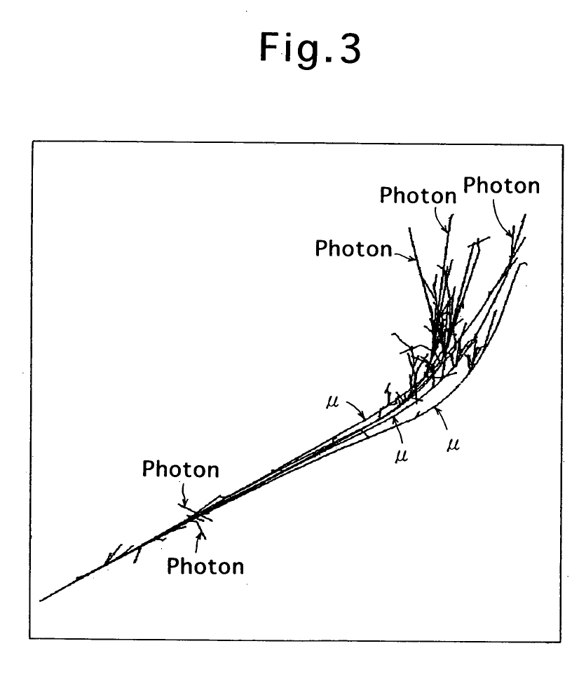

FIG. 3 shows the simulated tracks of the muons, electrons and bremsstrahlungs (photons) in the case where twenty-five positive muons each having an energy of 2 GeV are made to be incident into the thundercloud according to the computational model shown in FIG. 2. Among the tracks shown in FIG. 3, long and slowly curved tracks are the tracks of the muons (μ), and a large number of linear branching lines are the tracks of the bremsstrahlungs (photons). In FIG. 3, only the main tracks of the muons and photons are indicated with arrows. The secondary electrons are short in flying range and hence are seen as short lines in the neighborhood of the bremsstrahlungs (photons). It can be seen that, in this way, a large amount of electrons and bremsstrahlungs photons are emitted in a thundercloud.

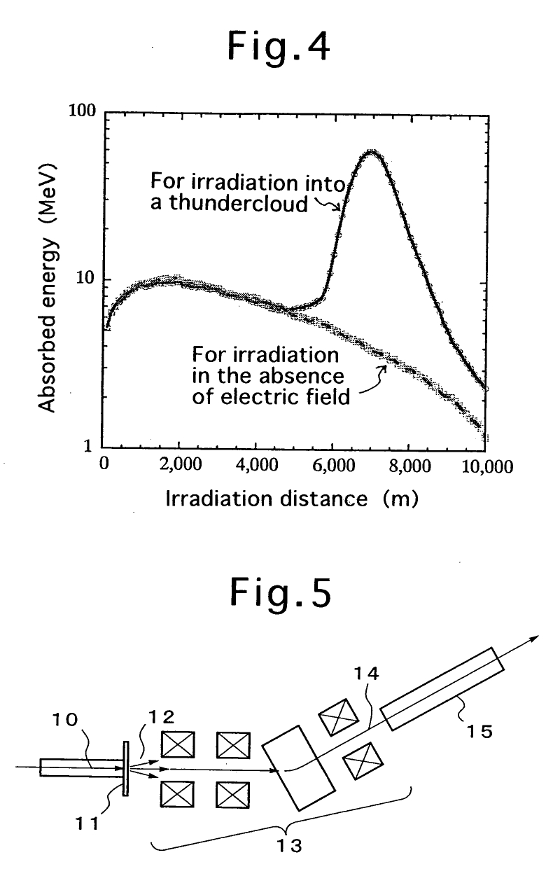

The energy absorbed in this case by the air along the irradiation direction of the muon beam is shown in the graph of FIG. 4. The abscissa axis of the graph represents the irradiation distance of the muon beam and the ordinate axis represents the energy deposition due to one muon irradiation. As can be seen from the graph, in the case where a muon beam is irradiated into the electric field of a thundercloud, the absorbed energy amount per muon is largely increased as compared to the case where irradiated under the condition such that no electric field is present, and the absorbed energy amounts to several tens MeV per muon. Since the energy required to create an electron-ion pair (W value) amounts to 34 eV in air, the absorption of the energy of several tens MeV conceivably generates about one million electron-ion pairs. Such generation of the electron-ion pairs leads to ionization of the surrounding air, resulting in the rise of the electric conductivity, so that even such an electric field strength in a thundercloud that cannot normally induce discharge can facilitate the occurrence of lightning discharge.

The simulated results illustrated in FIG. 3 and FIG. 4 are calculated by the Monte Carlo particle transport code GEANT4. (See S. Agostinelli et al., Nucl. Instr. And Meth. Phys. Res. A 506, 250-303 (2003).)

FIG. 5 is a schematic diagram illustrating a preferred example of an apparatus for triggering of lightning discharge which can be used to implement the triggered lightning discharge method of the present invention. More specifically, the apparatus for triggering of lightning discharge of the present invention is constituted with a high energy proton or electron accelerator (not shown in the figure), a target 11 to which the proton beam or the electron beam is irradiated, a collimator 13 for muons, and an accelerating tube 15 for a muon beam. The energy of the accelerator is varied depending on the energy of the muons to be irradiated into a thundercloud, and a high energy accelerator of several GeV to 10 GeV is generally used.

In the example illustrated in FIG. 5, a proton accelerator is used, a beam 10 of protons (p) emitted from the proton accelerator is irradiated to the target 11 made of carbon or the like, and pions and the like 12 are made to be emitted from the target 11. The pions decay to generate muons (μ). The generated muons are taken out and collimated using the collimator 13 including electromagnets and the like in such a way that the muons are converged and bent. The muon beam 14 thus collimated is finally accelerated by the accelerating tube 15, and the muons having acquired the predetermined energy are irradiated toward a thundercloud.

Additionally, the selection of the energy of the muons taken out from the muon beam 14 makes it also possible to vary the flying range of the muon beam and hence the distance to the target thundercloud.

1. A method for triggering of lightning discharge comprising collimating muons emitted from a high energy proton or electron accelerator, and irradiating the collimated muon beam toward a thundercloud to thereby promote ionization of air in the thundercloud and trigger lightning discharge.

2. An apparatus for triggering of lightning discharge comprising a high energy proton or electron accelerator from which a proton beam or an electron beam is emitted, a target from which pions are emitted by irradiating the target with the proton or electron beam, a collimator for collimating muons generated by the decay of the pions, and an accelerating tube for accelerating the collimated muon beam and irradiating the muon beam toward a thundercloud.
